(19) United States
(12) Patent Application Publication
(10) Pub. No.: US 2022/0178201 A1
(43) Pub. Date: Jun. 9, 2022

(54) CMP Screens

(71) Applicant: Edward Courtney MacPherson, Sydney (AU)

(72) Inventor: Edward Courtney MacPherson, Sydney (AU)

(21) Appl. No.: 17/112,983

(22) Filed: Dec. 5, 2020

(51) Int. Cl. E06B 9/52; B60J 1/20

(52) U.S. Cl. CPC E06B 9/52; E06B 2009/527; B60J 1/2011

(57) ABSTRACT

The present invention discloses a window screen that is particularly applicable for screening automobile windows. It is an object of this invention to provide a screen for motor car windows which is of simple, inexpensive manufacture, it can be moved adjustably up and down within the door and is effective and satisfactory in use.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to screen ventilation devices for automobiles, and particularly to a screen with an improved configuration, adjustably mounted in the window frame of a car door.

### DESCRIPTION OF THE RELATED ART

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Various screen devices for automobiles have been proposed. U.S. Pat. No. 2,491,574 to Morgan discloses a screen for a car window that attaches to and moves with the window.

U.S. Pat. No. 2,779,406 to Merewether discloses a screen for an automobile which is adjustable for different window sizes.

U.S. Pat. No. 23,805,712 to McVicker discloses a screen for an automobile which attaches by clips in the window frame.

U.S. Pat. No. 5,570,542 to Cameron discloses a screen for an automobile made up of a plurality of apertures.

All of the prior art patents disclose screens which are separately attached to the window openings of cars, to allow for circulation of fresh air while at the same time preventing the influx of bugs and debris.

The obvious shortcoming of the prior art devices, however, is that they require cumbersome attachment and removal of the screens, making them inconvenient and time consuming to install or remove. Moreover, the prior art screens do not provide protection from the sun. There remains a need for a car screen that allows passengers to raise and lower the screen quickly and easily in the window opening, as well as for a car screen that provides protection from solar heat and glare. None of the prior art methods have been found to be completely suitable to meet these needs and are cumbersome. The present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, and abstract as a whole.

The present invention discloses an improved car screen. The screen provides enhanced protection from bugs and debris without compromising visibility or ventilation.

It is an object of the present invention to provide an improved screen ventilation device for automobiles.

A further object is a vehicle window screen which is economical to manufacture, durable, and easy to remove and install.

It is principal object of the invention to overcome the defects of the prior art and allows the vehicle to stay cool in summer, less air resistance while driving and prevents bugs and insects from entering vehicle.

Another object of this invention is to provide a door for an automobile having a vertically sliding window glass, a vertically-sliding screen.

Another significant embodiment of the present invention is a screen assembly of the present invention that the laminate combination of the screen and frame forms a structure of high strength, able to withstand the wind speeds encountered when the vehicle is traveling at high rates of speed.

It is an object of the invention to provide improved elements and arrangements thereof in an apparatus for the purposes described which is inexpensive, dependable and fully effective in accomplishing its intended purposes.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 is a full view of the invention installed on the car window.

FIG. 200 is an inside view of the invention.

FIG. 300 is another inside view of the invention from the car.

FIG. 400 is a view of the electric motor system.

FIG. 500 is a view of the cylindrical hydraulic system.

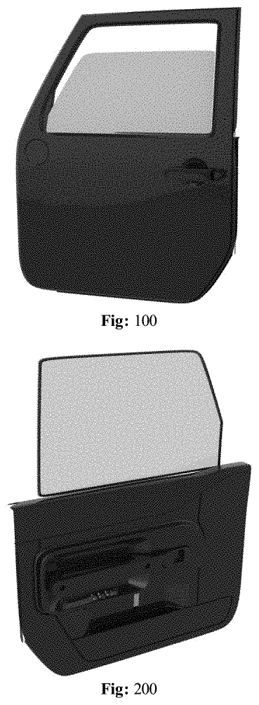

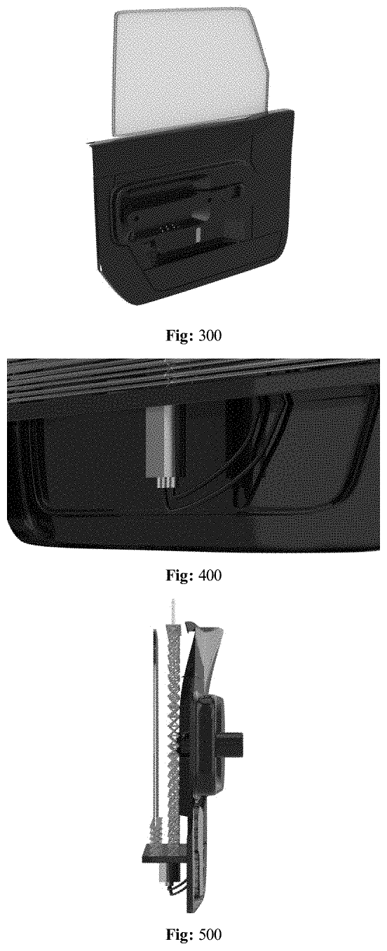

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

Unless otherwise defined, all terms (including technical and scientific terms) used herein have the same meaning as commonly understood by one having an ordinary skill in the art to which the invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques are disclosed. Each of these has individual benefit and each can also be used in conjunction with one or more, or in some cases all, of the other disclosed techniques. Accordingly, for the sake of clarity, this description will refrain from repeating possible combination in an unnecessary fashion. Nevertheless, the specifications and claim/s should be read with the understanding that such combinations are entirely within the scope of the invention and the claim/s.

The method of the present invention is that it relates to screen windows for vehicles. It allows the vehicle to stay cool in summer and prevents bugs and insects from entering vehicle. The invention is more secure than the prior art of glass windows.

Another embodiment of the present invention relates to an automobile window screen that will be retained in position notwithstanding the vibration caused by driving the automobile and will not interfere with the raising and lowering of the window.

Another embodiment of the present invention relates to ergonomically and aesthetically, it is desirable to have a curved screen window insert which accommodates the natural contour of the curved glass window of most standard vehicles as.

It is noted that the embodiment of a screen that can be mechanically or electric operated. The invention prevents bugs or debris from entering vehicle while moving or stopped.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1) The invention is a screen frame for vehicle windows comprising;
a. a frame screen for an automobile window;
b. a screen frame slidably engagable in said channel;
c. said screen frame being movable from a first position to a second position, and;
d. whereby sliding hydraulic system with screen frame may be moved up or down in said channel.

2) The invention prevents bugs or debris from entering vehicle while moving or stopped.

3) The window assembly wherein the height of the proposed invention is essentially identical to the height of the rear windows assembly to fit in cars universally.
